(19) United States
(12) Patent Application Publication
(10) Pub. No.: US 2017/0175704 A1
(43) Pub. Date: Jun. 22, 2017

(54) PRESSURE CONTROLLED WIND TURBINE ENHANCEMENT SYSTEM

(71) Applicant: NEW WORLD ENERGY ENTERPRISES LIMITED, Longford (IE)

(72) Inventors: James SMYTH, County Cavan (IE); Peter SMYTH, County Longford (IE); David SMYTH, County Longford (IE); Gerard SMYTH, County Longford (IE); Andrew SMYTH, County Armagh (GB)

(21) Appl. No.: 15/446,688

(22) Filed: Mar. 1, 2017

Related U.S. Application Data
(63) Continuation-in-part of application No. 13/378,930, filed on Jan. 12, 2012, now abandoned.

(30) Foreign Application Priority Data
Jun. 19, 2009 (IE) 20090476
Jul. 31, 2009 (IE) S20090598

(51) Int. Cl. F03D 1/04

(52) U.S. Cl. CPC F03D 1/04; F05B 2250/5011; F05B 2240/133

(57) ABSTRACT

The present invention provides a pressure controlled wind turbine enhancement system and a method of enhancing the airflow past a wind turbine, the enhancement system including a two part conical nozzle to be located upwind or upstream of a turbine in order to augment the natural flow of air past blades of the turbine in a manner which produces increased power output from the turbine.

### CROSS REFERENCE TO RELATED APPLICATIONS

This is a continuation in part of U.S. application Ser. No. 13/378,930, filed Jan. 12, 2012, which U.S. national stage of application No. PCT/EP2010/058655, filed on Jun. 18, 2010. Priority under 35 U.S.C. §119(a) and 35 U.S.C. §365(b) is claimed from Irish Patent Application Nos. 20090476, filed on Jun. 19, 2009, and S20090598, filed on Jul. 31, 2009, the disclosures of which are also incorporated herein by reference.

### FIELD THE INVENTION

This invention relates to a pressure controlled wind turbine enhancement system which can be integrated with new wind turbines or retrofitted to existing wind turbines. The design uses a modified nozzle, located directly upstream of a wind turbine. The use of a modified nozzle augments the airflow directed past the blades of the turbine in a manner which provides improved power output from the turbine.

### BACKGROUND OF THE INVENTION

In today's environment of global warming and environmental awareness, renewable energy is becoming more and more important, with wind turbines, both on and off shore, being the most well-established form of renewable energy. While turbines have proven a viable option for generating electricity, they do have their limitations. One of the main issues with wind turbines is a phenomenon known as the “Betz limit” which determines the maximum limit of a wind turbine's performance. This results from a pressure drop across the rotor of the turbine in which the air directly behind the blades is at sub-atmospheric pressure and the air directly in front of the blades is at greater than atmospheric pressure. This elevated pressure in front of the turbine, deflects some of the wind or upstream air around the turbine, thus putting a limit on the amount of work which can be extracted by the turbine.

However, this Betz limit is rarely reached in most wind turbines, due to fluctuating wind velocities, which is another drawback when using wind turbines. Wind velocity cannot be guaranteed, and therefore the power generated by wind turbines is inconsistent, and this obviously creates issues when supplying electricity for consumption. As a result it is normally necessary to carefully select the site at which wind turbines are located, choosing sites in areas having higher prevailing wind velocities, and also generally choosing sites of moderate elevation. It is also preferable to have the blades of the turbine located at a certain height off the ground, as wind velocity is generally higher at altitude as a result of the drag experienced at ground level and the lower viscosity of the air at height. Regardless of the height however, in airflow over solid bodies such as turbine blades, turbulence is responsible for increased drag and heat transfer. Thus in such applications, and in this case wind turbines, the greater the turbulence of the air or “wind” flowing over the blades, the less efficient the transfer of energy from the wind to the turbine blades.

WO2005/005820 (Davidson) discloses a rectangular shaped diffuser augmented wind turbine (DAWT). A DAWT generally takes the form of a duct located downstream of the blades of the turbine, whose purpose is to create a region of sub-atmospheric pressure within the diffuser directly downstream of the blades in order to draw more air through the blades to increase power generation. Davidson teaches that in order to augment airflow past a wind turbine a diffuser will create a region of reduced pressure downstream of the blades, in order to allow a greater volume of air to be drawn past the blades as a result of the pressure differential between the downstream and upstream locations on either side of the blades. This is achieved in Davidson through the use of a diffuser, and in particular having one or more gaps in the sidewall which allow air to enter the diffuser from the exterior airflow.

US2005/001432 (Drentham) discloses a bidirectional hydroelectric turbine arrangement which, regardless of the direction of tidal flow through the housing surrounding the turbine, will define a downstream diffuser in order to reduce the pressure downstream of the turbine, thereby preventing pressure build up in the forward portion of the housing positioned upstream of the turbine. As a result of the presence of the downstream diffuser there will be no problematic pressure build up in the forward or upstream portion of the housing, and thus no requirement to alleviate pressure build up in this forward portion. Indeed due to the presence of the diffuser at the rear end of the housing of Drentham, regardless of the direction of tidal flow, the gaps in the forward end will function in the reverse, drawing more fluid into the forward portion of the housing in order to meet the increased fluid flow requirements resulting from the presence of the diffuser at the rear end. Thus once a diffuser is present the gaps in the forward portion of Drentham will draw water into the housing. In addition the radially offset or stepped arrangement of the housing on either side of the gap will result in the generation of turbulence in the flow, which will be significant at higher flow rates as would be the case with wind turbines. As Drentham deals with water flow through the housing such high flow rates would not be experienced and so the issue of turbulence is not considered.

It is therefore an object of the present invention to provide a pressure controlled wind turbine enhancement system which is operable to accelerate and maintain the continuity of airflow, while also reducing the turbulence of said airflow, past blades of the turbine.

### SUMMARY OF THE INVENTION

According to a first aspect of the present invention there is provided a pressure controlled wind turbine enhancement system comprising a wind turbine having a set of blades; a nozzle comprising a cylindrical sidewall having an inlet and an outlet defining an airflow channel therebetween, the inlet having a larger cross section then the outlet, and a circumferentially extending vent in the sidewall defining a first section of the nozzle between the inlet and the vent and a second section of the nozzle between the vent and the outlet.

Preferably, the vent extends around substantially the full circumference of the nozzle.

Preferably, the vent comprises a number of discrete elongate circumferentially extending slots.

Preferably, the first section has a converging profile with respect to the direction of airflow through the nozzle and the second section has a converging diverging profile with respect to the direction of airflow and defining a throat region.

Preferably, the blades of the turbine are positioned at the throat region of the second section.

Preferably, the rate of convergence of the first section varies between the inlet and the vent such that the sidewall forming the first section forms a curved conical surface.

Preferably, the rate of convergence of the second section varies between the vent and the throat region such that the sidewall forming the converging part of the second section forms a curved conical surface.

Preferably, each section of the nozzle is substantially conical is shape.

Preferably, the rate of convergence of the first section is greater than the rate of convergence of the converging part of the second section.

Preferably, the vent is flush with the sidewall.

Preferably, the system comprises a base on which the nozzle is mounted.

Preferably, the nozzle is pivotable on or with the base.

Preferably, the base comprises a support to which a wind turbine is mountable.

Preferably, the system comprises guide means adapted to displace the nozzle to face into the wind.

Preferably, the blades of the turbine are located downstream of the outlet.

Preferably, the nozzle comprises no airflow augmenting elements located downstream of the blades of the turbine.

Preferably, the sidewall is continuous.

Preferably, the system adapted to be mounted to the exhaust of an existing it conditioning system.

According to a second aspect of the invention there is provided a method of enhancing the airflow across a wind turbine, the method comprising the steps of passing the airflow through a nozzle located substantially upstream of blades of the wind turbine, the nozzle comprising a cylindrical sidewall having an inlet and an outlet defining an airflow channel therebetween, the inlet having a larger cross section then the outlet, the method further comprising allowing at least a portion of the airflow to pass outwardly through a circumferentially extending vent in the sidewall from an interior to an exterior of the nozzle in order to allow pressure to be alleviated from the interior of the nozzle in order to accelerate and maintain the continuity of airflow and therefore reduce turbulence, the vent defining a first section of the nozzle between the inlet and the vent and a second section of the nozzle between the vent and the outlet.

Preferably, the first section has a converging profile with respect to the direction of airflow through the nozzle and the second section has a converging diverging profile with respect to the direction of airflow through the nozzle and defining a throat region, the method comprising positioning the blades of the turbine within the throat region.

Preferably, the method comprises allowing the airflow to pass directly from the blades through the outlet to the surrounding environment without passing through a diffuser.

Preferably, the method comprises positioning the blades downstream of the outlet and allowing the airflow to exit the outlet before flowing past the blades.

Preferably, the method comprises using the nozzle to augment the airflow exclusively upstream of the blades.

As used herein, the term “nozzle” in intended to mean an airflow guide which has an inlet having a larger cross sectional area than an outlet such that airflow through the lumen of the nozzle is accelerated.

### BRIEF DESCRIPTION OF THE DRAWINGS

FIG. 1 illustrates a front perspective view of a pressure controlled wind turbine enhancement system according to the present invention, located directly upstream of a wind turbine;

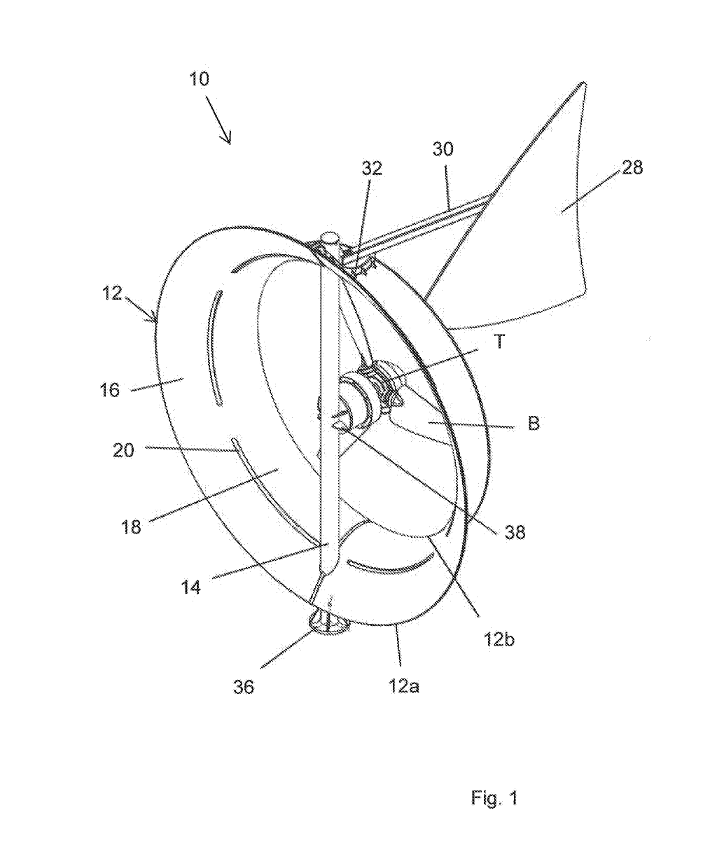

FIG. 2 illustrates a rear or downstream view of the pressure controlled wind turbine enhancement system;

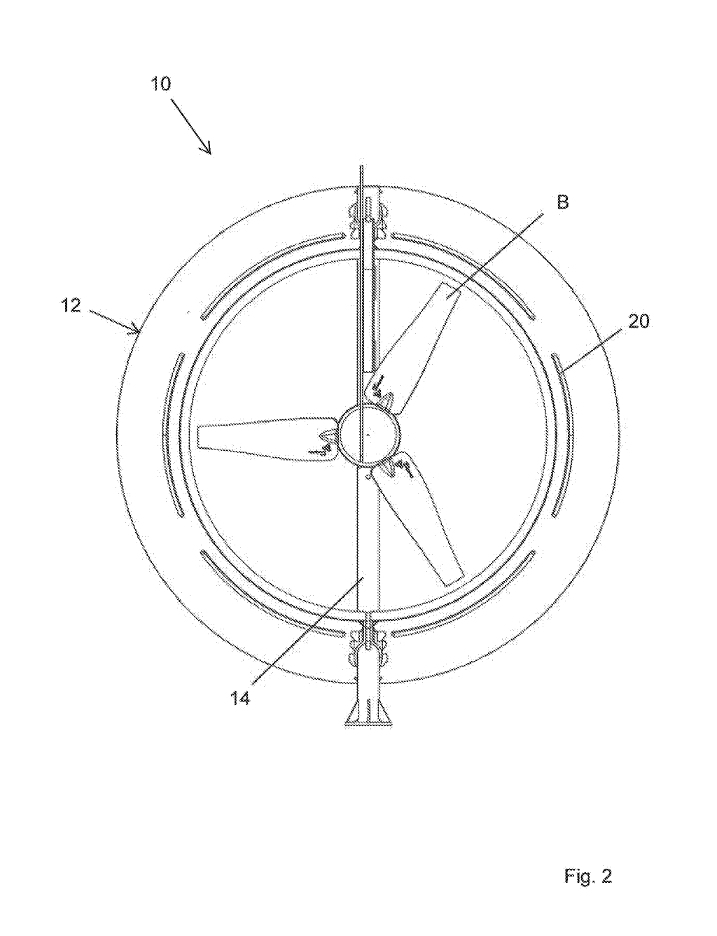

FIG. 3 illustrates a front or upstream view of the pressure controlled wind turbine enhancement system;

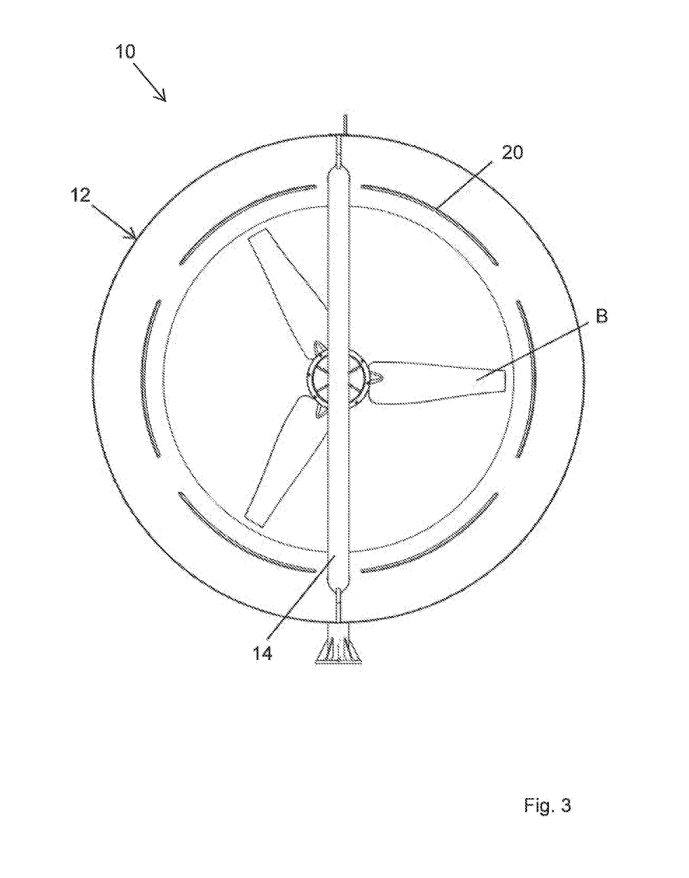

FIG. 4 illustrates a side elevation of e pressure controlled wind turbine enhancement system of FIG. 1;

FIG. 5 illustrates sectioned side view the pressure controlled wind turbine enhancement system;

FIG. 6 illustrates a computational fluid dynamics model of the pressure controlled wind turbine enhancement system illustrated in FIGS. 1 to 5;

FIG. 7 illustrates a perspective view of the pressure controlled wind turbine enhancement system of FIGS. 1 to 5 but with the blades of the turbine located at a throat region of a second section of a nozzle of the system;

FIG. 8 illustrates a sectioned side view of the pressure controlled wind turbine enhancement system with the alternative blade position of FIG. 7; and

FIG. 9 illustrates a computational fluid dynamics model of the pressure controlled wind turbine enhancement system with the alternative blade position of FIGS. 7 and 8.

### DETAILED DESCRIPTION OF THE DRAWINGS

Referring now to the accompanying drawings there is illustrated a pressure controlled wind turbine enhancement system, generally indicated as 10, which is adapted to augment the velocity and/or profile of the air flow past an otherwise conventional wind turbine T in order to improve the power output of said turbine T. It will be appreciated from the following description of the drawings, that the enhancement system 10 may be retro fitted to an existing wind turbine, or may be formed integrally with a new wind turbine.

The enhancement system 10 comprises a substantially conical nozzle 12 open at either end, an inlet 12a and an outlet 12b and mounted, in the preferred embodiment illustrated, to a base 14 in the form of a substantially conventional pole on which the nozzle 12 can rotate in order to track the prevailing wind, as will be described in detail hereinafter. The inlet 12a has a larger cross sectional area than the outlet 12b such that airflow through the nozzle is accelerated towards the blades B of the turbine T.

The nozzle 12 is comprised of a first section 16 and a second section 18 separated from one another by a circumferentially extending vent 20 which, in use, allows airflow to escape from the interior of the nozzle 12 in order to reduce pressure within nozzle 12. The first section 16 is defined between the inlet 12a and the vent 20 with the second section 18 being defined between the vent 20 and the outlet 12b. It is also envisaged that additional sections (not shown) may be provided, with each section then being separated from adjacent sections by a respective vent (not shown). The vent 20, in the embodiment illustrated, is in the form of a plurality of discrete elongate slots which are arranged in a circumferential array in order to define the vent 20, although alternative configurations are also envisaged. The vent 20 is preferably flush with the wall of the nozzle 12 in order to minimise the generation of turbulence as air flows through the nozzle 12 and past the vent 20. The vent 20 is preferably formed integrally during the manufacture of the nozzle 12, which is preferably moulded from a polymer or other suitable composite such as fibreglass, carbon fibre or the like, although any suitable material or combination of materials may be used. In this way the nozzle 12 can be formed from a single “continuous” or uninterrupted sidewall from the inlet 12a to the outlet 12b, although in practice the nozzle 12 may be manufactured as a number of segments, and in the embodiment illustrated is formed from two halves which can then be suitably secured to one another to form the finished cylindrical nozzle 12. In the embodiment illustrates the two halves of the nozzle 12 are secured together with the base 14 being captured therebetween. This smooth unbroken continuous surface minimises the generation of turbulence within the nozzle 12 as the airflow is accelerated, as described in detail hereinafter, thereby increasing the power extraction that may be achieved by the blades B of the turbine T.

The first and second sections 16, 18 may however be formed as separate parts that may then be secured in longitudinal spaced relationship to one another by a support (not shown) or the like in order to define a vent therebetween, for example in the form of circular array of struts extending across the vent between the first and second section 16, 18 and secured thereto. The nozzle 12 may also be reinforced by the provision of a number of reinforcing rings circumscribing both the first and second sections 16, 18. These may be of metal or any other suitable material. It will be appreciated that the construction of the nozzle 12, as well as the method of securing same to the base 14, could be varied once the underlying functionality, as provided by the vent 20 separating the first and second sections 16, 18, is maintained.

The enhancement system 10 further comprises a guide vane 28 mounted at a downstream position of the nozzle 12 on an arm 30 extending from an upper bracket 32 securing the arm 30 to the nozzle 12 and the base 14. A corresponding lower bracket 34 further secures the nozzle 12 to the base 14, which are then rotatable as a single unit by means of a coupling 36 located at the lower end of the base 14. This coupling 36 may take the form of a simple bearing or yaw mechanism or the like, and may be arranged to enable the base 14 to be mounted to any suitable support, for example a conventional wind turbine tower, a streetlight pole, a roof structure, or any other suitable location. The guide vane 28 is operable to allow the enhancement system 10 to weather vane in order to track the prevailing winds and therefore maximise the energy channelled onto the wind turbine T. This may be achieved in a number of alternative ways, for example use of an electronic and/or mechanical actuator (not shown) in order to track the prevailing wind and rotate the nozzle 12 or the enhancement system 10.

Turning then to the operation of the enhancement system 10, the nozzle 12 is of substantially truncated conical shape, the first section 16 having a converging profile with respect to the direction of airflow through the nozzle 12 and the second section 18 having a converging diverging profile with respect to the direction of airflow and defining a throat region directly upstream of the outlet 12b, downstream of which the blades B are located. The hub and generator components of the turbine T may however be located within the nozzle 12, and are preferably mounted to the base 14 via a suitable mount 38.

The rate of convergence of the first section 16 varies between the inlet 12a and the vent 20 such that the sidewall forming the first section 16 forms a curved conical surface. The rate of convergence of the second section 18 varies between the vent 20 and the throat region such that the sidewall forming the converging part of the second section 18 forms a curved conical surface. The rate of convergence of the first section 16 is preferably greater than the rate of convergence of the converging part of the second section 18. The diverging part of the second section 18, from the throat region to the outlet 12b, is relatively short longitudinally with respect to the overall length of the nozzle 12, and functions solely to provide a laminar or non turbulent exhaust of the airflow from the outlet 12b before the airflow passes the blades B, again ensuring optimum power transfer to the blades B of the turbine. The diverging part does not form a diffuser and the enhancement system 10 does not employ a diffuser or any other flow augmenting components or features downstream of the blades B, as these would be detrimental to the intended functionality of the system 10.

In use the system 10 is allowed to weather vane to face into the oncoming wind, which is then captured by the nozzle 12 and the airflow thus accelerated and redirected onto and across the blades B of the turbine T, in order to generate electricity.

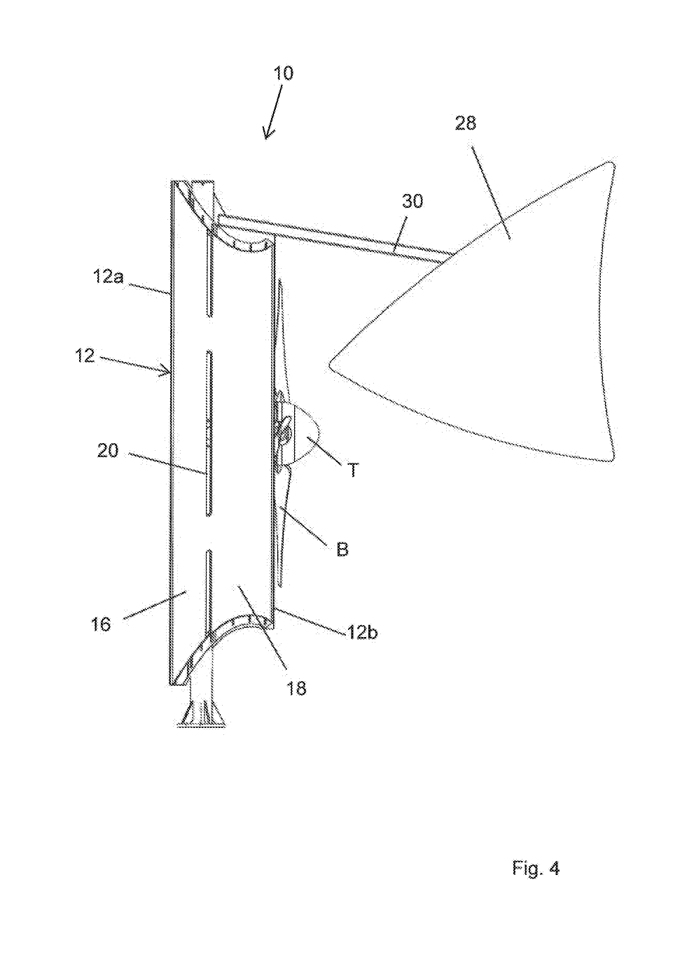

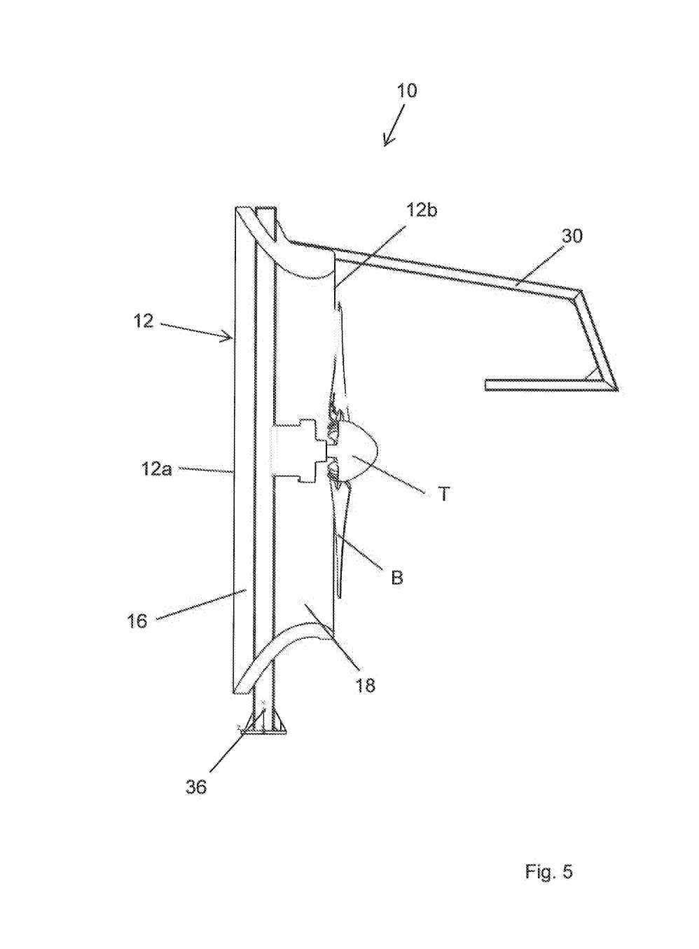

In use, the initially turbulent wind flows into the first section 16 of the nozzle 12, and due to the curving tapered shape of the first section 16, this wind is accelerated and redirected through the nozzle 12, while partially reducing the turbulence of the wind, a function assisted by the smooth curved profile of the first section 16. The wind then passes into the second section 18, with the vent 20 forming a transition between the first and second sections 16, 18. As mentioned above, the converging portion of the second section 18 has a shallower angle or lower rate of convergence relative to the first section 16, as can be clearly seen in FIGS. 4 and 5. In order to avoid excess pressure build up of the airflow on the interior sidewall of the nozzle 12, in particular as it passes from the first section 16 to the second section 18, the vent 20 allows some pressure to be alleviated from the interior of the nozzle 12, in order to accelerate the airflow and maintain the continuity of airflow and therefore prevent the introduction of turbulence at the transition between the first and second sections 16, 18.

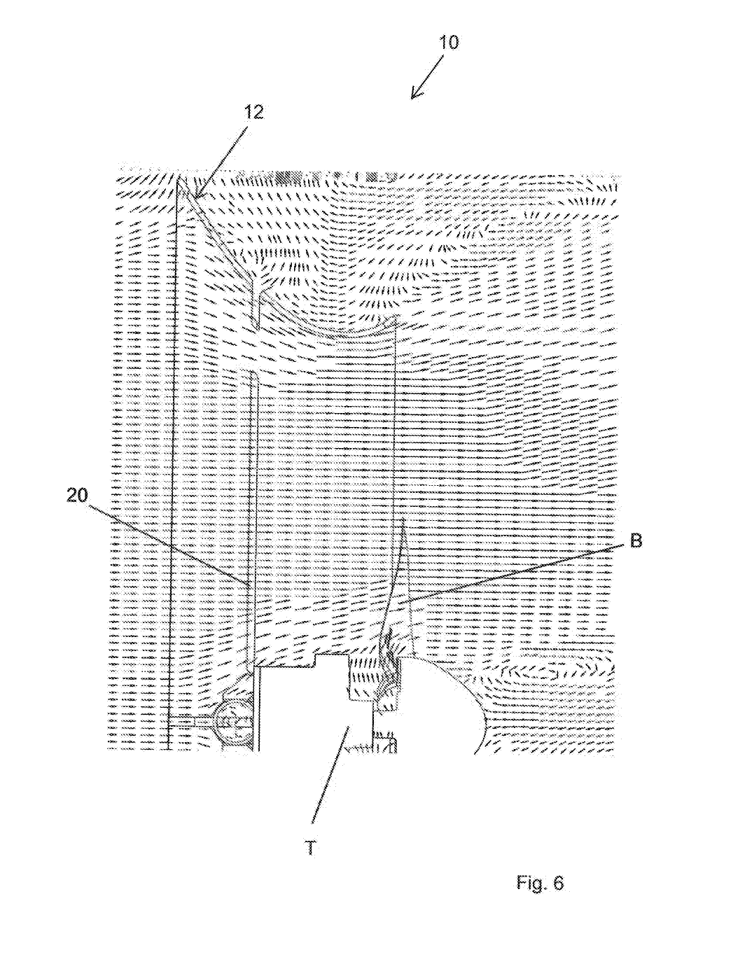

This venting of a portion of the airflow from the interior to the exterior of the nozzle 12 via the vent 20 is clearly illustrated in the computational fluid dynamics model of the enhancement system 10 illustrated in FIG. 6. In this model the velocity of the airflow is represented by the length of the arrows, the longer the arrow the greater the velocity. By forming the vent 20 flush with the sidewall of the nozzle 12 the vent 20 minimises the generation of turbulence within the nozzle 12 as the air flows both past and through the vent 20. The air that flows past the vent 20, being the majority of the airflow, then continues through the second section 18, where the velocity of the airflow is again increased due to the taper or convergence of the converging part of the second section 18, and the remaining turbulence is significantly reduced or eliminated. The accelerated airflow then exits via the diverging part of the second section 18, ensuring a smooth or turbulence free exhaust of the air before flowing across the wind turbine T in order to generate electricity or mechanical energy.

By reducing the taper or rate of convergence of the converging part of the second section 18 relative to the rate of convergence of the first section 16, the increase in pressure across the nozzle 12 can be controlled, in order to prevent excessive pressure being developed, which can restrict the volume of air which can then pass through the nozzle 12.

It will be appreciated that the basic shape and/or configuration of the enhancement system 10 may be varied while maintaining the above-mentioned functionality. As an example, the interior or the exterior surface of the nozzle 12, or the guide vane 28, could be provided with means for harvesting solar energy (not shown) mounted thereon, in order to supplement the power generated by the turbine itself. Alternatively the electricity generated by such solar energy harvesting means could be used to drive a starter motor of the wind turbine (not shown), in order to allow the turbine to operate during periods of reduced wind speed.

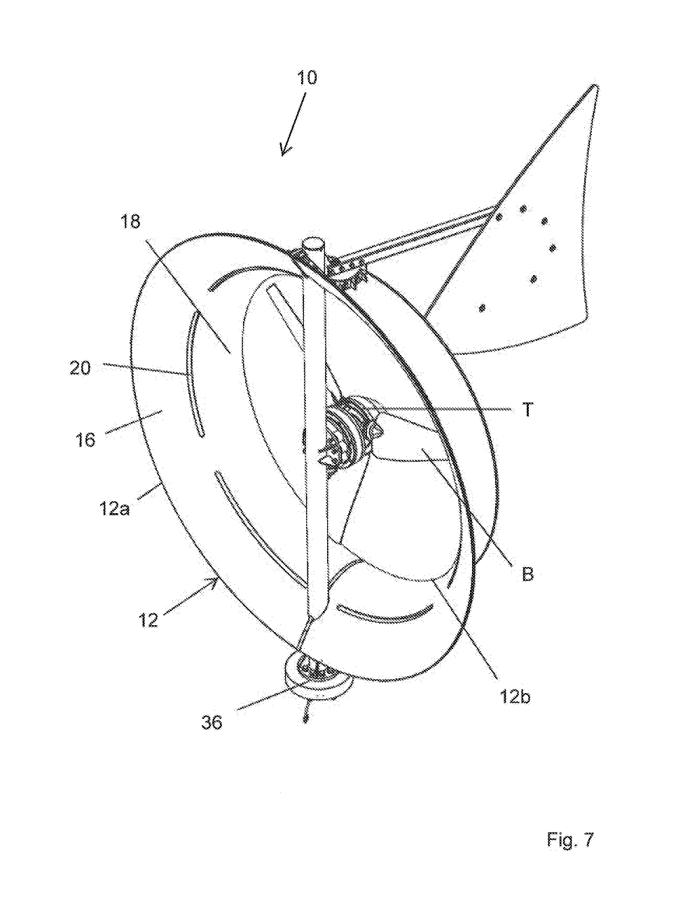

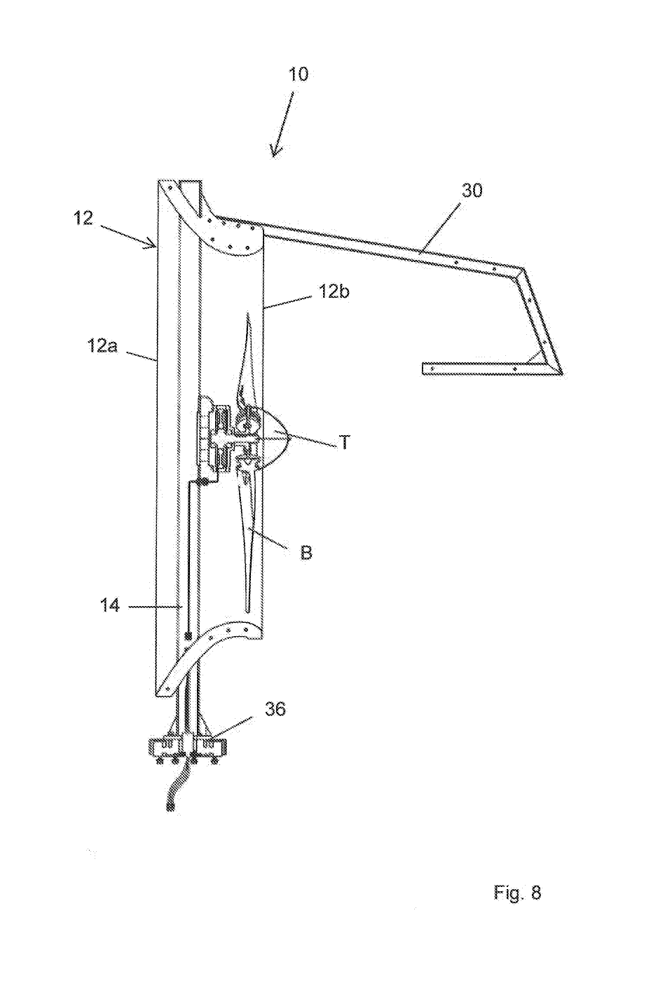

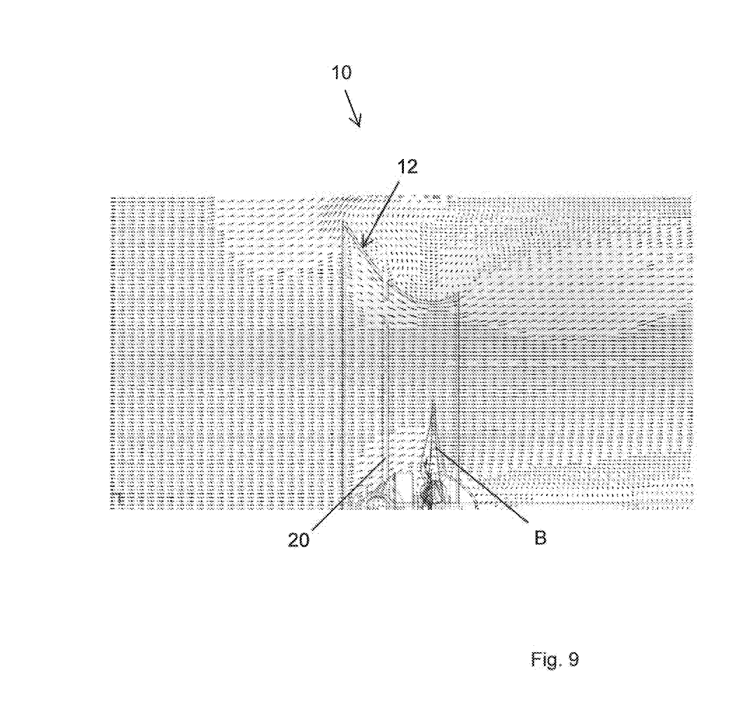

In addition, as illustrated in FIGS. 7 to 9, the position of the blades B of the turbine T may be varied slightly without negatively affecting the performance of the enhancement system 10. The blades B may be located slightly upstream of the outlet 12b, in the throat region of the second section 18, at which the airflow has reached maximum acceleration and reduced turbulence, in order to again optimise power extraction by the blades B. As can be seen in FIG. 9, a computational fluid dynamics model of the enhancement system 10 with the blades B located slightly upstream of the outlet 12b, the first and second sections 16, 18 and the vent 20 operate as described above with no discernable difference in performance.

The enhancement system 10 could also be mounted, for example, with the nozzle 12 in the locality of the exhaust of a relatively large scale ventilation system (not shown) for example as used in an underground car park or large office building or the like. Thus rather than wasting the energy in the exhausted air, it could be used to power the turbine T, with the aid of the enhancement system 10, in order to generate power.

By using the pressure controlled nozzle 12 of the present invention, a wind turbine can have an increased energy output. It should also be noted that as the turbine T is producing more energy per m² of the sweep area, the blades B can be reduced in size, and the height at which the blades B are positioned, can also be reduced, thereby reducing the initial cost of the turbine and increasing the number of sites at which wind turbines can be deployed. Thus for example the system 10 can be of a reduced size which would be more attractive both physically and financially for installation at commercial or residential sites in order to supply power directly to these locations.

The pressure controlled wind turbine enhancement system 10 of the present invention therefore provides a simple yet highly effective means and method of improving the performance of a wind turbine. The enhancement system 10 involves very few moving parts, which is beneficial for reliability while also minimizing cost. The various components of the turbine system 10 may be manufactured from any suitable material, but preferably from a lightweight material such as plastic, a composite, or other material.

1. A pressure controlled wind turbine enhancement system comprising a wind turbine having a set of blades; a nozzle comprising a continuous cylindrical sidewall having an inlet and an outlet defining an airflow channel therebetween, the inlet having a larger cross section then the outlet, and a circumferentially extending vent in the sidewall defining a first section of the nozzle between the inlet and the vent and a second section of the nozzle between the vent and the outlet.

2. A system according to claim 1 in which the vent extends around substantially the full circumference of the nozzle.

3. A system according to claim 1 in which the vent comprises a number of discrete elongate circumferentially extending slots.

4. A system according to claim 1 in which the first section has a converging profile with respect to the direction of airflow through the nozzle and the second section has a converging diverging profile with respect to the direction of airflow and defining a throat region.

6. A system according to claim 4 in which the blades of the turbine are positioned at the throat region of the second section.

6. A system according to claim 4 in which the rate of convergence of the first section varies between the inlet and the vent such that the sidewall forming the first section forms a curved conical surface.

7. A system according to claim 4 in which the rate of convergence the second section varies between the vent and the throat region such that the sidewall forming the converging part of the second section forms a curved conical surface.

8. A system according to claim 7 in which each section of the nozzle substantially conical is shape.

9. A system according to claim 4 in which the rate of convergence of the first section is greater than the rate of convergence of the converging part of the second section.

10. A system according to claim 1 in which the vent is flush with the sidewall.

11. A system according to claim 1 comprising a base on which the nozzle is mounted.

12. A system according to claim 11 in which the nozzle is pivotable on or with the base.

13. A system according to claim 11 in which the base comprises a support to which a wind turbine is mountable.

14. A system according to claim 1 comprising guide means adapted to displace the system to face into the wind.

15. A system according to claim 1 in which the blades of the turbine are located downstream of the outlet.

16. A system according to claim 15 in which the nozzle comprises no airflow augmenting elements located downstream of the blades of the turbine.

17. A system according to claim 1 in which the sidewall is continuous.

18. A system according to claim 1 adapted to be mounted to the exhaust of an existing air conditioning system.

19. A method of enhancing the airflow across a wind turbine, the method comprising the steps of passing the airflow through a nozzle located substantially upstream of blades of the wind turbine, the nozzle comprising a continuous cylindrical sidewall having an inlet and an outlet defining an airflow channel therebetween, the inlet having a larger cross section then the outlet, the method further comprising allowing at least a portion of the airflow to pass outwardly through a circumferentially extending vent in the sidewall from an interior to an exterior of the nozzle in order to allow pressure to be alleviated from the interior of the nozzle in order to accelerate and maintain the continuity of airflow and therefore reduce turbulence, the vent defining a first section of the nozzle between the inlet and the vent and a second section of the nozzle between the vent and the outlet.

20. A method according to claim 19 in which the first section has a converging profile with respect to the direction of airflow through the nozzle and the second section has a converging diverging, profile with respect to the direction of airflow through the nozzle and defining a throat region, the method comprising positioning the blades of the turbine within the throat region.

21. A method according to claim 19 comprising allowing the airflow to pass directly from the blades through the outlet to the surrounding environment without passing through a diffuser.

22. A method according to claim 19 comprising positioning the blades downstream of the outlet and allowing the airflow to exit the outlet of the nozzle before flowing past the blades.

23. A method according to claim 22 comprising using the nozzle to augment the airflow exclusively upstream of the blades.
